(19) United States
(12) Patent Application Publication
(10) Pub. No.: US 2008/0131837 A1
(43) Pub. Date: Jun. 5, 2008

(54) Arrangement for the detection of surface contours on objects, especially in the field of dentistry

(76) Inventors: Bernd Kordass, Neuenkirchen (DE); Matthias Busch, Hanau (DE)

Correspondence Address: COLLARD & ROE, P.C., 1077 NORTHERN BOULEVARD, ROSLYN, NY, 11576, US

(21) Appl. No.: 11/985,897

(22) Filed: Nov. 19, 2007

(30) Foreign Application Priority Data
Nov. 19, 2006 (DE) 10 2006 054 716.0

(51) Int. Cl. A61C 9/00

(52) U.S. Cl. 433/37

(57) ABSTRACT

An arrangement for the detection of surface contours of objects, especially in the field of dentistry, for generating a virtual 3D model, having an energy source, whose energy output is directed onto the surface of the object in order to deliver energy into the object. A sensor is provided on the side of the object away from the energy source, to detect the intensity of the energy emerging from the object. The energy absorbed in the object and determined in an energy difference module is coordinated with the layer thickness of the object, in order to image the respective surface contour by way of the layer thickness, as height information related to the surface of the incidence of energy into the object.

### CROSS REFERENCE TO RELATED APPLICATIONS

Applicants claim priority under 35 U.S.C. 119 of German Application No. 10 2006 054 716.0 filed Nov. 19, 2006.

### BACKGROUND OF THE INVENTION

1. Field of the Invention

The invention pertains to an arrangement for the detection of surface contours on objects, especially in the field of dentistry.

2. The Prior Art

The detection of surface contours serves, among other things, to determine the surface roughness or the degree and the shape of a profiling of materials. In many cases, the mutually oriented contour of objects is also of great importance, such as the positional relation of teeth situated in the upper jaw and lower jaw in the field of dentistry.

An arrangement for graphic colored detection of three-dimensional objects with a flat-bed scanner is described in German Patent No. DE 197 09 050 A1, in which an optical adapter is used. With this optical adapter, an enlargement of the object distance is achieved, so that three-dimensional objects can be arranged on a rotating support at a sufficient distance from the scanner. With the rotating support, the object is digitally detected in various views. A suitable software then creates three-dimensional data sets of the object surface.

Such a solution is suitable for the detection of colored, three-dimensional objects, but it is not possible to easily and precisely determine the various angles of rotation at which the object was optically detected, so that it is at least difficult to combine the individual images into an overall picture with sufficient precision.

Moreover, a device for making three-dimensional photographs of objects with optical scanners, and a method for three-dimensional object detection, are described in German Patent No. DE 198 19 992 A1. In such a method, the object is detected in two or more recording modes, in time sequence and/or at the same time, after which the detected data are saved in memory and processed by computer to produce a three-dimensional model.

The implementation of such a solution is costly, due to the need for an exact determination of the relative position of the object with regard to the optical scanning device, especially when the respective object needs to be detected in various positions by the scanning device, staggered in time.

### SUMMARY OF THE INVENTION

It is an object of the invention to detect and evaluate surface contours of objects, relative to the particular object, with comparatively simple means.

According to the invention, this object is achieved in an arrangement for the detection of surface contours on objects where the impression that coincides with its outer contour consists of an energy-absorbing material. A sensor is provided on the side of the object away from the energy source to detect the intensity of the energy emerging from the object. An energy difference module that detects the energy absorbed in the object and a reference unit are provided, in which the functional relationship between the energy absorbed by the object, or the impression, and the layer thickness is modeled basically perpendicular to the surface of incidence of the energy into the object or impression. This way, the energy absorbed in the object is detected in the energy difference module, proceeding from the energy intensity delivered into the object, on the basis of the residual energy leaving the object. The layer thickness is determined in the reference unit, in correlation to the decrease in energy intensity upon passing through the object or the impression, in order to image the respective surface contour in terms of the layer thickness, as height information related to the surface of incidence of energy into the object or the impression.

The invention creates the possibility of efficiently detecting surface contours of objects, with great precision, on the basis of the energy absorption in the object, in a model of the object, or in an impression of the object or of the model.

In a preferred embodiment of the invention, one surface region of the object has a defined geometric shape, which can be configured as a plane or a spherical cap, and it is provided preferably at the energy input side of the object.

The object or its impression can be formed from segments and be broken down into the latter. It is practical to provide a defined geometric shape, such as a plane or a spherical cap, on at least one segment of the object or the impression.

In one embodiment of the invention, the energy source is an electromagnetic radiation source, which emits a particular wavelength region or a particular wavelength. The energy source can also be a sonic source.

To make the reference values available, it is advisable to coordinate the object or its impression with a test body of similar material composition and structure, having a thickness that varies according to the energy input surface.

Moreover, the arrangement can have a holder device for positioning the object or its impression in a suitable position for an energy input. The holder device will preferably stand in a defined positional relation to the sensor, which detects the energy emerging from the object or the impression.

Furthermore, the object or its impression can be surrounded by a medium having defined transmission parameters, in order to control a defined energy input or a reproducible energy absorption behavior in the object or the impression.

The arrangement is preferably used in dentistry. In particular, it is used for a detection, representation, documentation, archiving and/or analysis of jaw or tooth models, of jaw or tooth impressions, of bite registrations, of bite and jaw relation registrations, and/or of tooth preparations.

In another embodiment of the invention, taking the impression of the object occurs in an impression device, which has at least one flat region, preferably consisting of transparent material, and can be configured as an impression spoon or impression tray.

It is practical if the impression device consists of several parts placed in a defined position relative to one another and removably joined together.

The parts of the impression device can be coordinated with segments of the impression. Thus, there is the possibility of detecting the surface contour of the object as the negative contour copied in the impression, using the energy absorption in one or more segments of the impression.

However, one can also detect the negative contour of the impression by delivering the energy into at least one part of the impression device and into the corresponding segment of the impression, preferably one connected to the corresponding part of the impression device, and detecting the overall energy absorption.

In this connection, it is practical if the materials used for impression device and impression are coordinated with one another in terms of their energy transmission behavior.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of an arrangement for the detection of surface contours of a dental object according to one embodiment of the invention;

FIG. 2 shows a dental object embedded in an impression compound;

FIG. 3 shows an impression device for taking an impression of an upper jaw; and

FIG. 4 shows an upper jaw impression consisting of several segments, produced with an impression device in accordance with FIG. 3.

### DETAILED DESCRIPTION OF THE PREFERRED EMBODIMENT

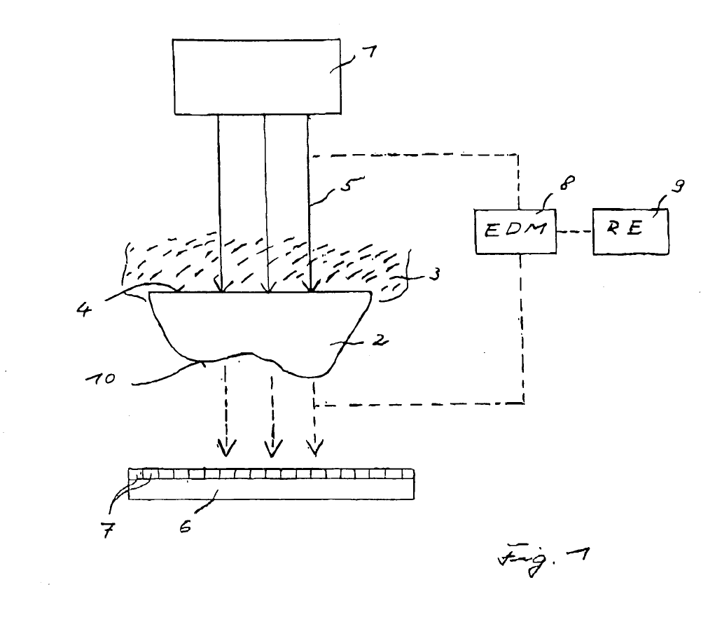

Referring now in detail to the drawings, FIG. 1 shows an energy source 1, which emits light of a particular wavelength in the direction of a tooth model 2, which consists of a translucent material that absorbs energy. Tooth model 2 is encased in a medium 3, such as a gel or a silicone oil, to adapt the light entry parameters, such as the index of refraction, to the chosen material and the optical properties of tooth model 2, and it has a flat light entry surface 4 on the side facing energy source 1.

The light radiation emitted by energy source 1 impinges onto light entry surface 4 of tooth model 2, essentially perpendicularly, as indicated by arrows 5, passes through the model, losing energy, and is detected by a sensor 6 located on the side of tooth model 2 away from energy source 1.

Sensor 6 extends two-dimensionally perpendicular to the plane of the drawing, and has a plurality of sensor elements 7 in a two-dimensional raster, coordinated with surface regions of corresponding size on light entry surface 4 of tooth model 2, which runs basically parallel to them. Sensor elements 7 thus coordinated with light entry surface 4 each detect the residual energy of the radiation after it emerges from tooth model 2.

In energy difference module 8, the energy absorbed in tooth model 2 is determined on the basis of the energy emitted by energy source 1 and delivered into tooth model 2, and the residual energy emerging from tooth model 2 and detected by sensor elements 7.

Using a functional relationship between the absorbed energy in tooth model 2 and the thickness of tooth model 2, saved in memory in a reference unit 9, height information with reference to the particular sensor element 7 is generated. The virtual detection of surface contour 10 of tooth model 2 occurs in connection with the known coordination of sensor elements 7 with corresponding surface regions of light entry surface 4.

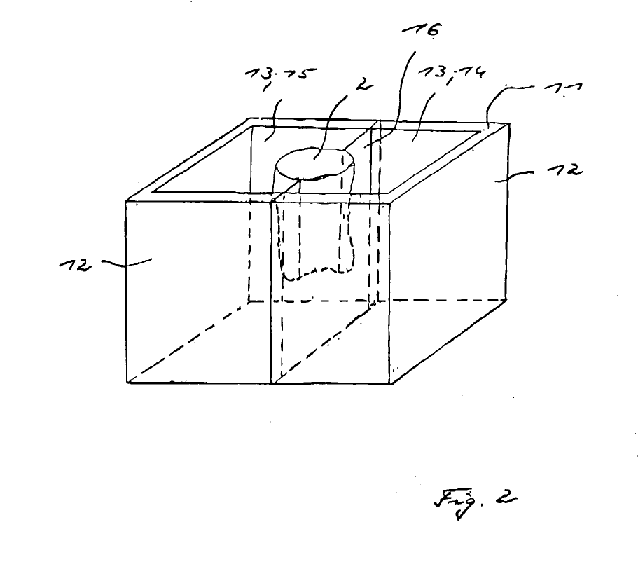

If a suitable light entry surface 4 is not provided for the radiation, or if one cannot be created for the contours being copied, the possibility exists, as shown in FIG. 2, of arranging tooth model 2 in a block-shaped or cubical hollow body 11 with planar or otherwise determinate side surfaces 12. The space between tooth model 2 and side surfaces 12 of hollow body 11 is filled with impression material, so that the resulting impression 13 copies both the surface of tooth model 2 and the inner walls of hollow body 11. Thus, the configuration of the inner walls of hollow body 11 determines light entry surface 4 of impression 13.

To detect surface contour 10 of tooth model 2, impression 13 is separated into segments 14 and 15. It is practical if the parting plane is implemented by an intermediate layer 16 or a film web.

The negative contour of tooth model 2 is determined from segments 14 and 15 of impression 13 by means of the described arrangement for the detection of surface contours.

Surface contour 10 of tooth model 2 can accordingly be determined from the negative contour of the relevant segments for the particular application, using known software.

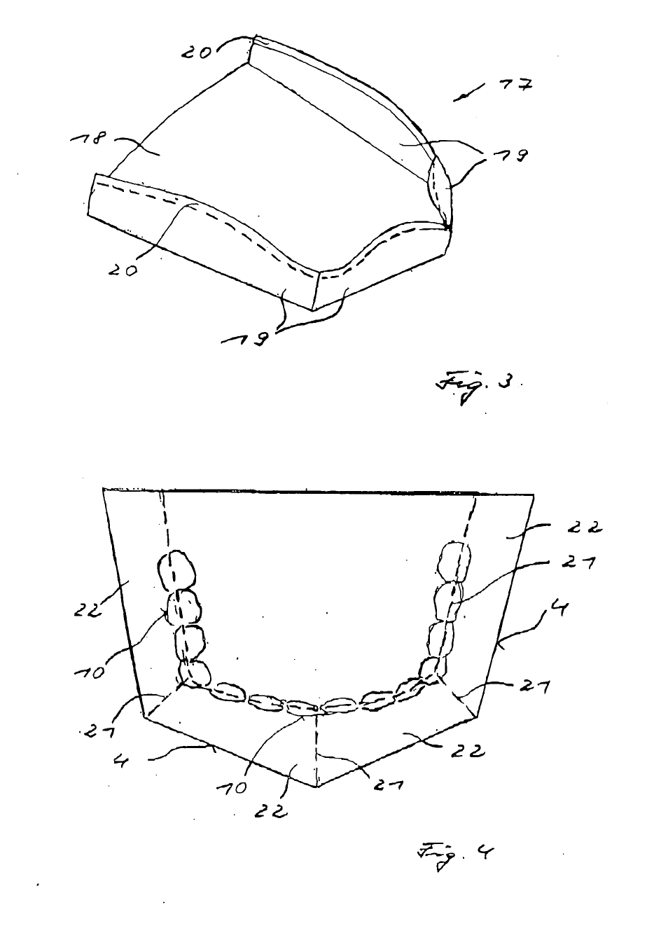

To detect surface contours 10 of several teeth and of jaw regions, one can use an impression spoon 17 as an impression device similar to a hollow body. According to FIG. 3, impression spoon 17 for taking an impression of the upper jaw consists of a flat spoon bottom 18 and flat wall elements 19, whose edge zones 20 are shaped to suit the anatomical conditions. Spoon bottom 18 and wall elements 19 consist of transparent material and are removably joined together, so that spoon bottom 18, as well as wall elements 19, can each be provided separately with impression compound, to produce a negative impression, and can be evaluated independently of one another, regarding surface contour 10 of the dental object being detected.

Furthermore, FIG. 4 shows an impression 13 of the teeth of an upper jaw, produced in an impression spoon 17 in accordance with FIG. 3. Impression 13 is segmented by separation cuts 21 running as far as spoon bottom 18. Separation cuts 21 run both in the region of impression 13 of the teeth and also radially outward, in such a manner that resulting segments 22 are available separately or in a desired combination, for the determination of the negative surface contour.

Since impression spoon 17 is multipartite, the possibility also exists of separating segments 22 of impression compound 13, each connected to a wall element 19, and of detecting the negative surface contour of the particular partial impression.

Accordingly, while only a few embodiments of the present invention have been shown and described, it is obvious that many changes and modifications may be made thereunto without departing from the spirit and scope of the invention.

What is claimed is:

1. An arrangement for the detection of surface contours of objects for generating a virtual 3D model, comprising:
an energy source, whose energy output is directed onto a surface of the object in order to deliver energy into the object;
a sensor disposed on a side of the object away from the energy source to detect intensity of energy emerging from the object;
an energy difference module that detects energy absorbed in the object; and
a reference unit,
wherein the object or an impression that coincides with an outer contour of the object consists of an energy-absorbing material, and
wherein a functional relationship between the energy absorbed by the object or the impression and layer thickness is modeled in the energy difference module and reference unit, essentially perpendicular to a surface of incidence of the energy into the object or the impression, so that the energy absorbed in the object is detected in the energy difference module from the energy intensity delivered into the object, on the basis of residual energy leaving the object, and the layer thickness is determined in the reference unit, in correlation to a decrease in energy intensity upon passing through the object or the impression, in order to image a respective surface contour in terms of the layer thickness, as height information related to a surface of incidence of energy into the object or the impression.

2. An arrangement for detection of surface contours according to claim 1, wherein one surface region of the object has a defined geometric shape.

3. An arrangement for the detection of surface contours according to claim 2, wherein the defined geometric shape of the surface region of the object is configured as a plane or a spherical cap.

4. An arrangement for the detection of surface contours according to claim 2, wherein the defined geometric shape of the surface region of the object is provided on an energy input side of the object.

5. An arrangement for the detection of surface contours according to claim 1, wherein the object or its impression is formed from segments and can be broken down into said segments.

6. An arrangement for the detection of surface contours according to claim 5, wherein a defined geometric shape is provided on at least one segment of the object or the impression.

7. An arrangement for the detection of surface contours according to claim 1, wherein the energy source is an electromagnetic radiation source, which emits a particular wavelength range or a particular wavelength.

8. An arrangement for the detection of surface contours according to claim 1, wherein the energy source is a sonic source.

9. An arrangement for the detection of surface contours according to claim 1, wherein the object or its impression is coordinated with a test body of similar material composition and structure as the object, with thickness varying according to the energy input surface.

10. An arrangement for the detection of surface contours according to claim 1, further comprising a holder device for positioning the object or its impression in a suitable position for an energy input.

11. An arrangement for the detection of surface contours according to claim 10, wherein the holder device stands in a defined positional relation to the sensor, which detects the energy emerging from the object or the impression of the object.

12. An arrangement for the detection of surface contours according to claim 10, wherein the object or its impression is surrounded by a medium having defined transmission parameters, in order to control a defined energy input or a reproducible energy absorption behavior in the object or the impression.

13. An arrangement for the detection of surface contours according to claim 1, wherein the arrangement is used in dentistry.

14. An arrangement for the detection of surface contours according to claim 13, wherein the arrangement is used for a detection, representation, documentation, archiving or analysis of jaw or tooth models, of jaw or tooth impressions, of bite registrations, of bite and jaw relation registrations, or of tooth preparations.

15. An arrangement for the detection of surface contours according to claim 13, further comprising an impression device which has at least one flat region, for taking jaw or tooth impressions.

16. An arrangement for the detection of surface contours according to claim 15, wherein the impression device is configured as an impression spoon or impression tray.

17. An arrangement for the detection of surface contours according to claim 15, wherein the flat region consists of transparent material.

18. An arrangement for the detection of surface contours according to claim 15, wherein the impression device consists of several parts placed in a defined position relative to one another and removably joined together.

19. An arrangement for the detection of surface contours according to claim 18, wherein the parts of the impression device are coordinated with segments of the impression.
